(19) United States
(12) Patent Application Publication
(10) Pub. No.: US 2010/0039893 A1
(43) Pub. Date: Feb. 18, 2010

(54) METHOD FOR SEISMIC MONITORING OF A FORMATION HYDRAULIC FRACTURING

(75) Inventors: Arkady Yurievich Segal, Moscow (RU); Mark Jean Thiercelin, Addison, TX (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 12/088,593

(22) PCT Filed: Sep. 27, 2006
(86) PCT No.: PCT/RU06/00497

§ 371 Date: Oct. 8, 2008

(30) Foreign Application Priority Data
Sep. 28, 2005 (RU) 2005130065

(51) Int. Cl. G01V 1/40; E21B 47/00

(52) U.S. Cl. 367/38; 367/37

(57) ABSTRACT

The invention relates to oil-gas engineering, in particular to maintaining wells in the oil-gas industry and, more specifically the hydraulic fracturing seismic monitoring.

A first method is carried out when a pulse amplitude is sufficient for opening a strike-slip fractures around a crack, wherein said crack is detectable with the aid of traditional means for passively recording seismic waves produced by acoustical events related to the opening of strike-slip fractures and by interpreting the position of the thus obtained events in the form of the events adjacent to the crack.

A second method is carried out by using a sharp difference of temporal sequences of a pressure pulse generated in the well and microearthquakes produced around a crack and consists in processing data received from seismic receivers in such a way that a signal similar to the well pressure pulse is separated, in locating the source of said pulse by analysing the times of the arrival thereof to the receivers and in identifying said pulse source with the area directly adjacent thereto.

The proposed invention relates to oil-gas engineering, in particular to maintaining wells in the oil-gas industry and, more specifically the hydraulic fracturing seismic monitoring.

In the oil and gas industry created hydraulic-fracture is the main tool of the well stimulation through channel creation or thickening from borehole to oil-bearing bed. In general, the operation is carried out by means of hydraulic fluid injection into the well, going through the subsurface bed. The fluid is pumped into the bed under pressure. As a result, the fractures appear leading to creation or thickening of the one or more fractures with the effect of oil yield enhancement from the oil-bearing bed. The same technology is used for the gas production stimulation in the gas fields or geothermal steam generation.

The importance of the hydraulic-fracture monitoring is explained by the necessity to control the fracture geometry for granting a compliance of the progress of work to specification. Another point is the necessity to acquire data about pattern of the multiple fracture distribution in case of large-scale works in the vast oil/gas/geothermal fields. Among various hydraulic-fracture monitoring techniques the passive seismic monitoring became the most common one, when one registers acoustic waves emitting either during the hydraulic-fracture execution, or after the process as a result of “micro earthquakes” evoked by intense effect on the zones adjacent to the fracture. Micro earthquakes source locations have to be defined. The revealed patterns show hydraulic-fracture surrounding zones (e.g., see US application number 2005190649, publ. Sep. 1, 2005).

The advantage of the passive seismic monitoring is that it is a real time process, finally providing one with the fracture distribution patterns data. The disadvantage is associated with the necessity to use an offset well to map micro earthquakes sources in a number of cases. Often the acquired source cluster is rather vague to define precisely fracture locations. Thus, this common technique has an immense potential for optimization. One of the optimization areas is to find out how to distinguish micro earthquakes adjacent to fracture from the ones rather distant from it.

The proposed methodology may help to identify the afore-said micro earthquake sources, adjacent to fracture.

Technology is based on emission of the high amplitude pressure pulse into the maintained well. Such pulses can be emitted either by specific installations, supplied in addition to routine equipment, or by standard machine, such as hydraulic pump. Specifically, natural strong pressure pulse results from the pump shutdown.

There are several modifications of the methodology. A first method is carried out when a pulse amplitude is sufficient for opening a strike-slip fractures around a crack, wherein said crack is detectable with the aid of traditional means for passively recording seismic waves produced by acoustical events related to the opening of strike-slip fractures and by interpreting the position of the thus obtained events in the form of the events adjacent to the crack.

A second method is carried out by using a sharp difference of temporal sequences of a pressure pulse generated in the well and microearthquakes produced around a crack and consists in processing data received from seismic receivers in such a way that a signal similar to the well pressure pulse is separated, in locating the source of said pulse by analyzing the times of the arrival thereof to the receivers and in identifying the said pulse source with the area directly adjacent thereto.

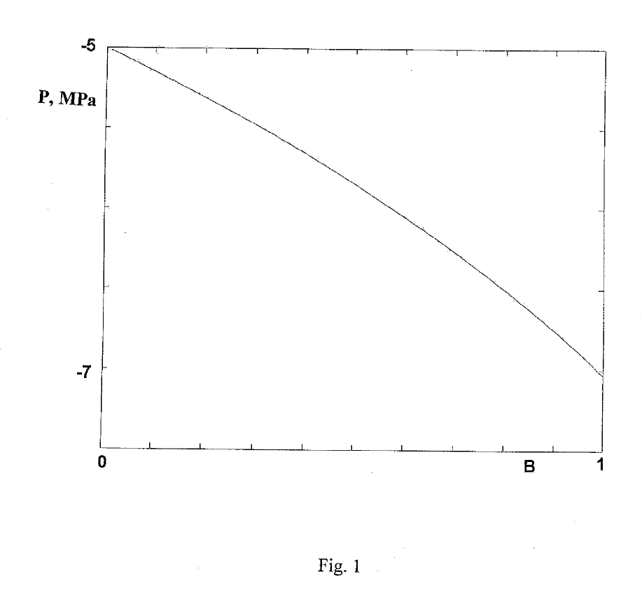

The invention is illustrated by FIGS. 1-4:

FIG. 1 shows relation of the fracture opening pressure (P) to the environment coefficient (B);

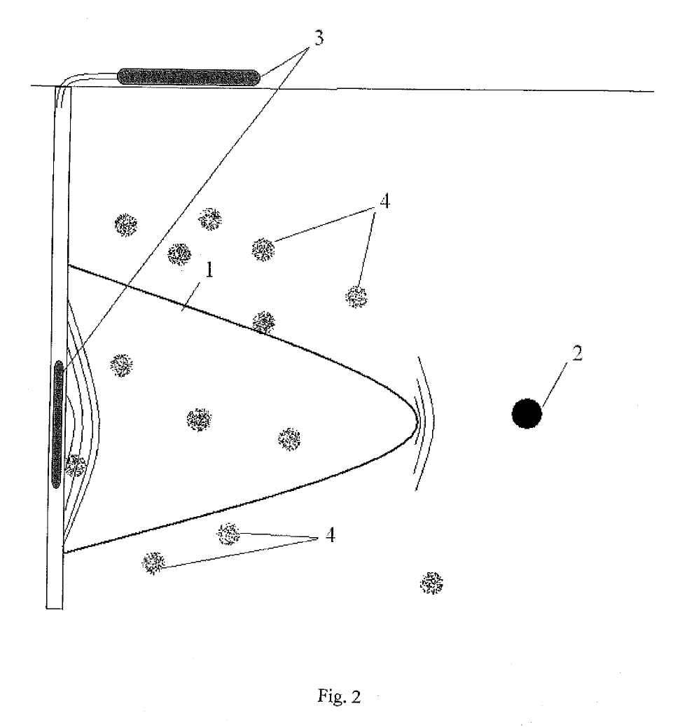

FIG. 2 is an illustration of the second methodology in the process;

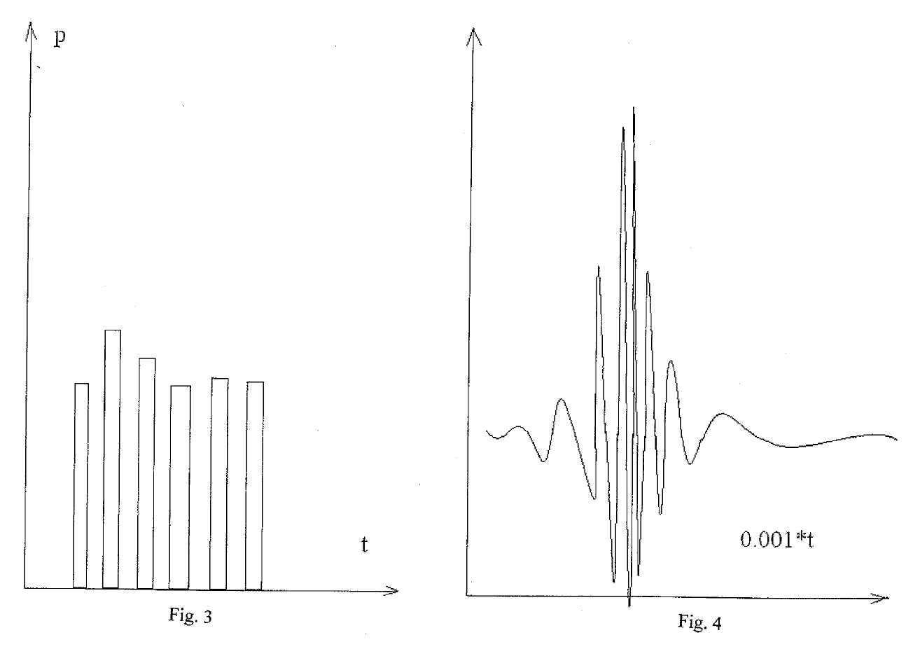

FIG. 3 shows a pressure pulse sample profile;

FIG. 4 depicts a characteristic acoustic emission signal (e.g. the element of particle acceleration).

The first technique of the seismic hydraulic-fracture monitoring, when the pressure pulses are applied to the maintained well, can be implemented through the following sequence of operations:
1) Low frequency (0-100 Hz) high amplitude (approximately 5-10 MPa) pressure pulses are emitted into the maintained well during or after the hydraulic-fracture process. The pressure pulses should propagate into the fracture and create specific dynamic disturbances in the zones adjacent to hydraulic-fracture for reactivation of cracks existing before long in the vicinity of the hydraulic-fracture. However, the pulses amplitude should not exceed some limits, avoiding the fracture dimensions instability which may result in the fracture closure.
2) Location of the fracture is identified. Basic science of cracks reactivation in the fractures vicinity is similar to the one, thus the fracture positioning could be made by means of routine passive seismic monitoring.
3) Acquired data on locations of the micro earthquakes' hypocenters is related to the nearest fracture zones, and therefore gives an opportunity to contour the fracture pattern rather more precisely.

The pressure pulse, propagating along the fracture walls, gives rise to strike slip cracks formation in the vicinity of the fracture. Therefore, detection of the specific micro earthquakes allows tracking the agitated acoustic wave sources that helps to map fraction location more accurately.

Working frequencies and amplitudes of the pulses can be inferred either through analytical assessment, or by means of mathematical modeling. Strike slip crack formations adjacent to fracture were studied by both analytical approaches and numerical methods. In the latter case, the dynamic equations of elastic bodies for a definition of hydraulic-fracture, generated in the liquid by inner pressure pulses, and subsequent analysis of the compliance with the Mohr-Coulon criteria for strike slip cracks formation near the fractures, was applied. In particular, considering stress condition in a site where maximum principal effective stress equals σₘₐₓ (defined as a difference between combined stress and interstice pressure) and minimal effective stress equals σₘᵢₙ, in the event of positive compression stress the Mohr-Coulon ratio means that the strike slip crack appears when works the following inequation:

σₘₐₓ−N* σₘᵢₙ≧K, (1)

N=tg²* (π/4+φ/2) (2)

where N—constant, defined by angle of friction; K—constant, equals to compression stress. The case of K=0 is considered to prove a former created shift fault existence. If the inequation (1) works, the possibility is that two cracks appear with the maximum tension angles equal to ±(π/4+φ/2). Strike slip cracks can appear and spread in the distances up to several meters across the fracture, given the pressure pulse in a liquid is low (approximately 0-15 Hz) and the amplitude is high (approximately 5-10 MPa) for the fracture width of 1-30 mm.

Descent approximation of the pressure pulse value sufficient for opening of the early created shift faults can be inferred from static load on fracture crack consideration. Specifically, static load, appearing in the fracture due to the liquid pressure increase by p, is considered for impervious rock under given stress conditions in the distance from the fracture, where s₁—is a maximum stress, and S₂—is a minimum stress (assuming a long flat fracture to spread along the maximum stress line). As the load is considered small enough not to effect maximum and minimum stress directions, the stresses in the bed are equal:

σₘₐₓ=s₁, σₘᵢₙ=s₃+p, (3)

thus, the Mohr-Coulon ratio is valid, if works the following:

p≧−s₃ +(s₁−K)/N (4)

For example, if s₁=40 Mpa, s₃=18 MPA, N=3, K=0 then p=−4,667 MPa, that is good enough for the pressure pulse approximation, which causes cracking, even under unsteady condition. Thus, the pulse with the amplitude of (4) or higher is produced, that is usually sufficient for opening again the shift faults around hydraulic-fracture.

Approximate pressure value for cracks formation in the porous medium could be inferred from the following. Given combined stress in the distance from the fracture equals to:

σₘₐₓ^{ff}=s₁, σₘᵢₙ^{ff}=S₃ (5)
and interstice pressure equals to p₀,
then, the fracture load with liquid pressure incrementing by p will cause uploaded condition having the following principal parameters:

σₘₐₓ=s₁, σₘᵢₙ=s₃+p, (6)
while interstice pressure difference in a process with negligible fluid diffusion through the interstice (undrained condition) depends on combined stress as shown in the following formula:

$$Δ {p}_{o} = \frac{B}{3} {\sum }_{i = 1 , 2 , 3} {σ}_{ii} = \frac{B}{3} ( 1 + v ) ( {Δ σ}_{max} + {Δσ}_{min} ) , \qquad ( 7 )$$

where ν—Poisson coefficient; B—environment coefficient. If deformation is considered flat, then 0<B<1.

In case of homogeneous static rupture stress the equations (6) are followed by

Δσₘₐₓ=0, Δσₘᵢₙ=p. (8)
Effective stresses are equal

σₘₐₓ^{eff}=s₁−T, σₘᵢₙ^{eff}=s₃+p−T

T=p₀+Δp₀ (9)
and the Mohr-Coulon ratio comes to the following modification

(s₁−T)−N(s₃+p−T)−K≦0, (10)

Thus, the following ratios for the cracking pressure are inferred:

$$p \leq \frac{{s}_{1} - {Ns}_{3} + ( N - 1 ) {p}_{0} - K}{{B}^{′} ( 1 - N ) + N} , {B}^{′} ≡ \frac{B}{3} ( 1 + v ) , 0 \leq B \leq 1 / 2 \qquad ( 11 )$$

Assuming K=0, s₁=55 Mπa, s₃=40 Mπa, p₀₌25 Mπa, N=3, ν=0,3, the dependence of pressure from B was calculated (FIG. 1). FIG. 1 shows weak relation of pressure and B, but at the same time strike slip cracks could easier result from smaller values of B. One should note that this calculation technique should be applied only for undrained conditions. If the condition is under the question in static, then in high-frequency regime it is valid. High-frequency pulse modeling was performed using 2d FD software. The analysis of the Mohr-Coulon ratio for the strike slip cracks proved the possibility of their formation, while the pressure amplitudes were in close relation with the model simulated ones (11).

Preferable way for realization of the second invention technique is a detection of the seismic signal that is similar to the pressure pulse in the well. The signal should be filtered from general data received by passive monitoring equipment by standard post processing methods, such as time series analysis of the signal reaching the receiver. The source of the signal should be mapped, and related further on to the hydraulic-fracture location.

Indeed, characteristic micro earthquake seismic signal around a well is quiet stochastic and short term high amplitude one. As a rule it is a wide band emission, but it is rather distinct from any other earthquake sequences. Therefore, if periodical low frequency pressure pulse (e.g. 0-100 Hz) is emitted, it could be clearly detected from the tome series registered by seismic receivers. FIG.2 shows principal scheme of the second hydraulic-fracture monitoring technique by means of pressure pulses application to the maintained well. The notations are the following: 1—hydraulic-fracture; 2—receiver; 3—possible site of the pressure pulse generation equipment; 4—acoustic emission hypocenters.

FIG. 3 and 4 show the seismic signal, resulted from pressure pulses in the well and fracture, is definitely distinct from earthquake seismic signals related to hydraulic-fracture by both profile and duration. It makes possible to detect pressure signal from the seismogram, recorded by remote sensor, and then reveal the hydraulic-fracture crack as a source of the pressure signal emission.

Original pressure pulse enters hydraulic-fracture crack and moves along its walls up to the crack edge, where it emits into formation and being registered by passive monitoring seismic receivers. By the way time series sequence is distorted, but remains explicitly different from the earthquake seismic signals. Thus, the crack surface becomes a source of the seismic signal shapely similar to the original pressure pulse. That is why the definition of the signal means indeed the mapping of the crack surface.

Seismic hydraulic-fracture monitoring technology, offered in two application techniques, provides an opportunity to detect a location of the crack surface with the precision, which beats any ever known seismic methods. Remarkable, that the result can be achieved by using routine field equipment.

1. A method of optimization of passive seismic monitoring of hydraulic fracturing job, characterized in that during or after hydraulic fracturing job a pressure pulsing is applied to a treatment well with the amplitude sufficient to open shear faults around the fracture, seismic signals from the acoustic events associated with the opening of shear faults are detected via the passive seismic system detectors disposed near the treatment well and the fracture surface boundaries are identified via the location of shear faults.

2. A method of optimization of passive seismic monitoring of hydraulic fracturing job, characterized in that during or after hydraulic fracturing job a pressure pulse is applied to a treatment well, seismic signals are detected via the passive seismic system detectors disposed near the treatment well, a signal similar to the pressure pulse in the well is separated from detectors seismograms, a source of this signal is localized and the fracture surface boundaries are identified via the location of the signal source.

3. The method of claim 2, characterized in that the signal source similar to the pressure pulse in the well is localized by analyzing the time of its arrival at the detectors.

4. The method of claim 1 or 2, characterized in that a pressure pulsing is applied during hydraulic fracturing job or after hydraulic fracturing job.
